(19) United States
(12) Patent Application Publication
(10) Pub. No.: US 2005/0216343 A1
(43) Pub. Date: Sep. 29, 2005

(54) Advertisement distribution method and advertisement distribution system

(75) Inventor: Mitsuhiro Tokorotani, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Infrontia Corporation

(21) Appl. No.: 11/090,071

(22) Filed: Mar. 28, 2005

(30) Foreign Application Priority Data
Mar. 29, 2004 (JP) 2004-095690

(51) Int. Cl. G06F 17/60

(52) U.S. Cl. 705/14

(57) ABSTRACT

A server apparatus communicable with an information communication terminal stores coupon ticket data for displaying a coupon ticket issued by an advertiser and advertisement data for displaying an advertisement screen including a content of an advertisement made by the other advertiser, encrypts the coupon ticket data, generates a packet that includes the encrypted coupon ticket data, the advertisement data, and control data for indicating the coupon ticket data to be decoded when display of the advertisement data is completed, and transmits the generated packet to the information communication terminal. The information communication terminal displays the advertisement screen based on the advertisement data included in the packet received from the server apparatus, decodes the coupon ticket data when it is detected that the display of the advertisement screen is completed, and effectively displays the coupon ticket.

### BACKGROUND OF THE INVENTION

1. Field of the Invention

The present invention relates to a method for distributing an advertisement to a cellular telephone terminal or an information communication terminal such as a personal computer owned by a customer in the form of electronic data.

2. Description of the Related Art

There are conventionally known methods for distributing an electronic advertisement of an article, a service or the like to an information communication terminal owned by a customer as disclosed in, for example, Japanese Patent Application Laid-Open (JP-A) Nos. 2002-133270, 2003-256714, and 2002-259788. The method disclosed in JP-A No. 2002-133270 is to cause an advertisement transmitter to distribute an advertisement email under conditions for a customer group to which the advertisement email is to distributed, a distribution time, and the like when these conditions are input. The method disclosed in JP-A No. 2003-256714 is to cause a server that provides a user terminal with pages of transmitted information to count the number of accesses from the user terminal per page, and to delete the page and notify a new page when a count number reaches an upper limit.

The method disclosed in JP-A No. 2002-259788 is to cause an advertisement distribution company to distribute a password in place of a coupon ticket such as a space and electronic information to a member that satisfies predetermined conditions, and to provide the member with a predetermined service when the member presents this password to a relevant shop.

The method disclosed in JP-A No. 2002-133270 can improve advertisement efficiency by setting advertisement email distribution conditions. The method disclosed in JP-A No. 2003-256714 can control the server to provide a newer advertisement based on the number of accesses to each page. However, with the methods disclosed in both JP-A Nos. 2002-133270 and 2003-256714, it is disadvantageously unclear whether the customer has actually read a content of the distributed advertisement mail or each page. Due to this, if the advertisement mail or page which is not read but abandoned by the customer is present, an unnecessary advertisement cost is disadvantageously required, accordingly.

With the method disclosed in JP-A No. 2002-259788, the coupon ticket is transformed to the password, thereby avoiding loss of the coupon ticket. However, since an advertisement target per distribution is limited to a shop that has issued the password, it is disadvantageously difficult to improve advertisement efficiency.

### SUMMARY OF THE INVENTION

The present invention has been achieved in view of the conventional disadvantages. It is, therefore, an object of the present invention to provide an advertisement distribution method capable of improving a cost performance of an electronic advertisement.

According to a first aspect of the present invention, there is provided an advertisement distribution method comprising steps of: causing a server apparatus communicable with an information communication terminal to store coupon ticket data for displaying a coupon ticket issued by an advertiser on the information communication terminal, and advertisement data for displaying an advertisement screen that indicates a predetermined advertisement content on the information communication terminal, to encrypt the coupon ticket data, to generate a packet that includes the encrypted coupon ticket data, the advertisement data, and control data for indicating the coupon ticket data to be decoded when display of the advertisement data is completed, and to transmit the generated packet to the information communication terminal; and causing the information communication terminal to display the advertisement screen corresponding to the advertisement data included in the packet received from the server apparatus, to decode the coupon ticket data when the display of the advertisement screen is completed, and to display the coupon ticket.

According to a second aspect of the present invention, there is provided an advertisement distribution system comprising: an information communication terminal; and a server apparatus communicable with the information communication terminal, wherein the server apparatus includes: a data storage unit storing coupon ticket data for displaying a coupon ticket issued by an advertiser on the information communication terminal, and advertisement data for displaying an advertisement screen that indicates a predetermined advertisement content on the information communication terminal; an encryption processing unit encrypting predetermined coupon ticket data stored in the data storage unit; a packet generation unit generating a packet that includes the coupon ticket data encrypted by the encryption processing unit, predetermined advertisement data stored in the data storage unit, and control data for indicating the coupon ticket data to be decoded when display of the advertisement data is completed; and a packet transmission unit transmitting the packet generated by the packet generation unit to the information communication terminal, and wherein the information communication terminal includes: a screen display unit displaying the advertisement screen corresponding to the advertisement data included in the packet received from the server apparatus; and a display control unit decoding the coupon ticket data when it is detected that the screen display unit completes the display of the advertisement screen, and displaying the coupon ticket on the screen display unit.

According to the present invention, when the information communication terminal which has received the packet uses the coupon ticket, it is required to complete the display of the advertisement screen. It is, therefore, possible to ensure that a user of the information communication terminal views the advertisement screen. It is thereby possible to avoid waste of the advertisement cost resulting from abandonment of an electronic advertisement without reading it.

### BRIEF DESCRIPTION OF THE DRAWINGS

FIG. 1 is a block diagram of an advertisement distribution system according to one embodiment of the present invention;

FIG. 2 is a block diagram that depicts a configuration of a server apparatus according to the embodiment;

FIG. 3 is an explanatory view for a rainbow packet according to the embodiment;

FIG. 4 is a sequence chart that depicts procedures for operations performed by a system according to the embodiment;

FIG. 5 is an explanatory view for an operation screen of the server apparatus according to the embodiment;

FIG. 6 is a flowchart of procedures for generating the rainbow packet according to the embodiment;

FIG. 7 is a flowchart of procedures for operations performed by a cellular telephone according to the embodiment; and

FIG. 8 is an explanatory view for display screens of the cellular telephone according to the embodiment.

### DESCRIPTION OF THE PREFERRED EMBODIMENT

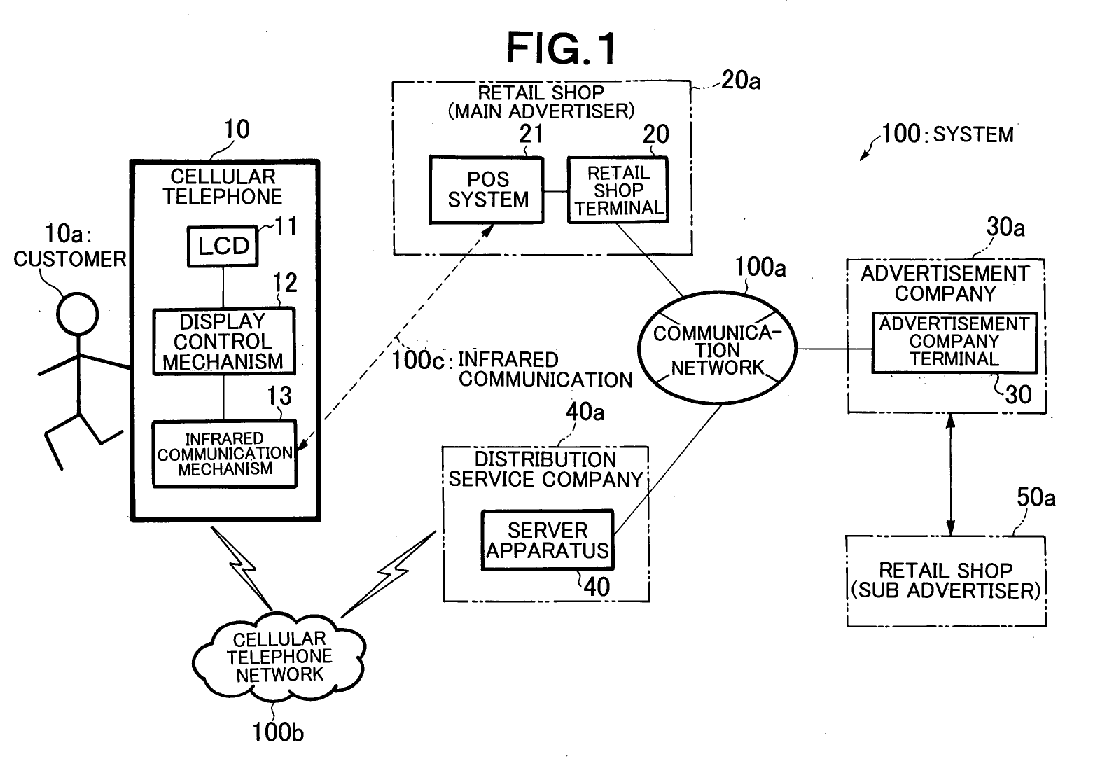

An embodiment of the present invention will be described hereinafter in detail with reference to the drawings. FIG. 1 is a block diagram of an advertisement distribution system according to the embodiment of the present invention. The advertisement distribution system 100 according to this embodiment includes a cellular telephone 10 that is an information communication terminal owned by a customer 10a, a retail shop terminal 20 owned by a retail shop 20a that provides a predetermined service, an advertisement company terminal 30 owned by an advertisement company 30a that runs an advertisement service, and a server apparatus 40 owned by a distribution service company 40a, which apparatus is connected to the advertisement company terminal 30 and the retail shop terminal 20 through a communication network 100a such as the Internet, and communicable with the cellular telephone 10 through a cellular telephone network 100b.

The distribution service company 40a runs an advertisement distribution service carried out by transmitting a rainbow packet, to be described later, from the server apparatus 40 to the cellular telephone 10. The distribution service company 40a plans and generates a content, a design, and the like of an advertisement to be distributed. The distribution service company 40a also receives an advertisement distribution service request from each of the retail shop 20a and the advertisement company 30a, and collects a fee from each of the retail shop 20a and the advertisement company 30a.

The retail shop 20a is an advertiser that issues a coupon ticket for providing a predetermined service such as a price discount or providing a sample article. The retail shop 20a concludes a contract with the distribution service company 40a in advance with respect to the advertisement distribution service. The advertisement company 30a receives a contract for an advertisement request from a retail shop 50a different from the retail shop 20a. The advertisement company 30a concludes a contract with the distribution service company 40a in advance with respect to the advertisement distribution service.

The retail shop 50a according to this embodiment is an advertiser that puts an advertisement of its own shop using the advertisement distribution service which the retail shop 20a requests to the distribution service company 40a, and requests the advertisement company 30a to take procedures regarding the advertisement of its own shop. In this embodiment, for the convenience of description, it is assumed that the retail shop 20a that issues the coupon ticket is a main advertiser and that the other retail shop 50a is a sub advertiser.

As shown in FIG. 1, the cellular telephone 10 of the customer 10a includes a liquid crystal display (LCD) 11 serving as a screen display mechanism that displays a screen, a display control mechanism 12 that exercises controls over a processing for displaying a moving image or a static image on the LCD 11, a decoding processing to be described later, and the like, and an infrared communication mechanism 13 that holds an infrared communication 100c with a conventionally known point-of-sale (POS) system 21 for making a sales management at the retail shop 20a.

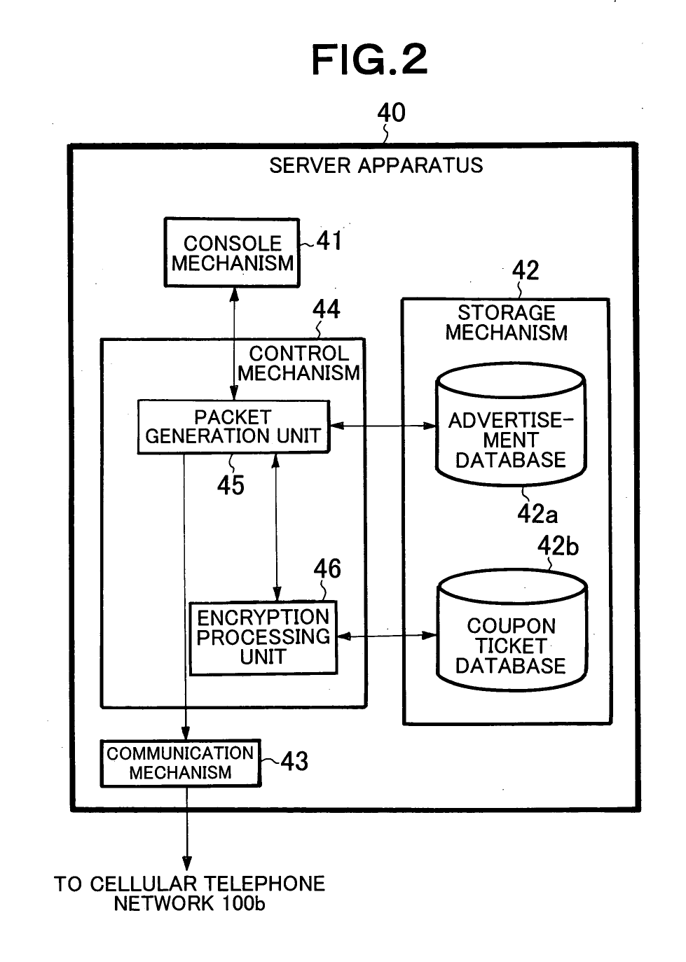

FIG. 2 is a block diagram that depicts a configuration of the server apparatus 40 of the distribution service company 40a. As shown in FIG. 2, the server apparatus 40 includes a console mechanism 41 including an input device and a display device, a storage mechanism 42 that stores data, a communication mechanism 44 that communicates with the cellular telephone 10 through the cellular telephone network 100b, and a control mechanism 45 that controls operations of the server apparatus 40. The storage mechanism 42 includes an advertisement database 42a that stores advertisement data for displaying a screen that indicates an advertisement content on the cellular telephone 10, and a coupon ticket database 42b that stores coupon ticket data for displaying a coupon ticket on the cellular telephone 10.

The advertisement data according to this embodiment is moving image data, which data is generated on the console mechanism 41 by an operator of the server apparatus 40 or generated outside of the server apparatus 40, and is stored in the advertisement database 42a. By causing the cellular telephone 10 to reproduce this advertisement data, an advertisement screen on which the moving image appears as the advertisement data is displayed on the LCD 11 of the cellular telephone 10. The advertisement data may be static image data in place of the moving image data as described in this embodiment.

The coupon ticket data according to this embodiment is data which enables the cellular telephone 10 to present the coupon ticket to the POS system 21 by the infrared communication 100c. The coupon ticket data is stored in the coupon ticket database 42b in a similar method to that for storing the advertisement data.

As shown in FIG. 2, the control mechanism 44 includes, as its functional constituent elements, an encryption processing unit 46 that encrypts the coupon ticket data to be distributed to the cellular telephone 10, and a packet generation unit 45 that generates a rainbow packet using the encrypted coupon ticket data and the advertisement data. The encryption processing unit 46 extracts the coupon ticket data corresponding to the retail shop 20a serving as the main advertiser from the coupon ticket database 42b, and encrypts the extracted coupon ticket data by a predetermined encryption system. As the encryption system, a common key system having relatively short encryption and decoding processing time is preferably adopted. Alternatively, the other system may be adopted.

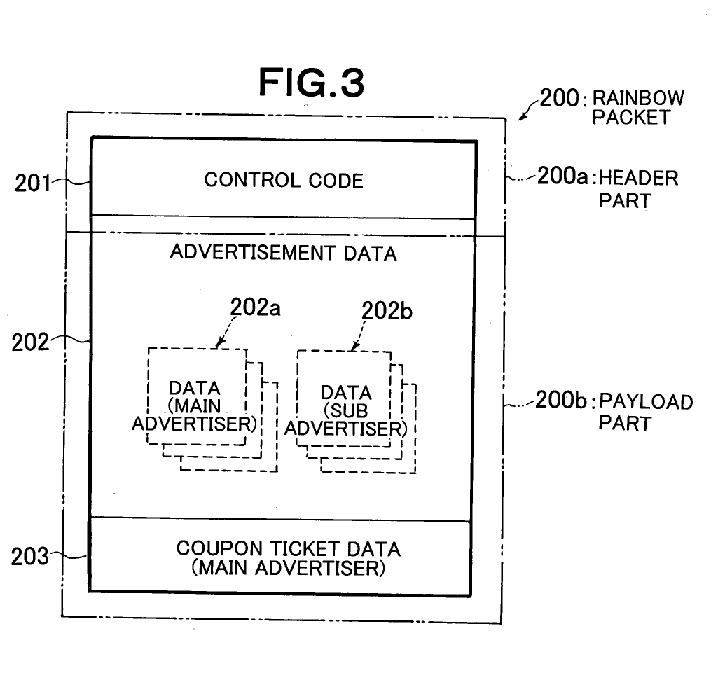

FIG. 3 is an explanatory view for the rainbow packet according to the embodiment. The rainbow packet 200 is a communication packet configured so that advertisement data 202 to be distributed to the cellular telephone 10 and coupon ticket data 203 encrypted by the encryption processing unit 46 are stored in a payload part 200b, and so that a control code 201 for indicating the coupon ticket data 203 to be decoded when the display of the advertisement data 202 is completed is stored in a header part 200a.

The control code 201 is software for indicating processing procedures for processing this rainbow packet 200 to the cellular telephone 10 that receives the rainbow packet 200. The cellular telephone 10 reproduces the advertisement data 202 in the form of a moving image while referring to the control code 201, and executes a predetermined routine relating to the processing for decoding the coupon ticket data 203 when the reproducing of the advertisement data 202 is completed.

If the encryption system of the coupon ticket data 203 is the common key system, then the encryption processing unit 45 generates a duplicate of an encryption key as a decoding key and stores the generated duplicate in, for example, the control code 201. In this case, the cellular telephone 10 validates the coupon ticket using the key stored in the control code 201 when detecting that the reproducing of the advertisement data 202 is completed.

As a method for causing the cellular telephone 10 to detect that the reproducing of the advertisement data 202 is completed, a method for causing the server apparatus 40 to set a reproducing time corresponding to a data amount of the advertisement data 202 to the control code 201 as a parameter in advance may be, for example, used. With this method, the cellular telephone 10 starts counting the reproducing time simultaneously with the start of the reproducing of the advertisement data 202, and stops counting it when the reproducing is suspended. Thereafter, when a count value of the reproducing time reaches a set value of the control code 201, the cellular telephone 10 determines that the reproducing of the advertisement data 202 is completed.

Alternatively, a method for storing “END OF FILE” data indicating an end of the advertisement data 202 in an end of the advertisement data 202 in the rainbow packet 200 may be executed in place of the method using the timer stated above. With this method, the cellular telephone 10 monitors whether the “END OF FILE” data is present in parallel to the reproducing of the advertisement data 202. The cellular telephone 10 determines that the reproducing of the advertisement data 202 is completed when recognizing this “END OF FILE” data.

Further, by burying a decoding key in the advertisement data 202, the cellular telephone 10 can simultaneously detect the completion of the reproducing of the advertisement data 202 and acquire the key. Specifically, if the reproducing time of the advertisement data 202 is 30 seconds and the key data is six bytes, for example, then the key data is divided in one-byte units and key data parts are buried in the advertisement data one byte by one byte for every five seconds. With this method, the cellular telephone 10 acquires one-byte key data whenever the advertisement data 202 is reproduced for five seconds. When the acquired data amount amounts to six bytes, the key data is completed. Using this key, the coupon ticket data 203 is decoded.

It is noted that data for allowing the cellular telephone 10 to distinguish which of the above-stated methods relating to the determination that the reproducing of the advertisement data 202 is completed and the decoding processing is adopted is stored in the control code 201 in advance.

As shown in FIG. 3, the advertisement data 202 according to this embodiment includes not only data 202a indicating the content of the advertisement of the retail shop 20a serving as the main advertiser but also data 202b on the retail shop 50a serving as the sub advertiser. By causing the cellular telephone 10 to reproduce this advertisement data 202, advertisement screens of different advertisers are displayed either continuously or simultaneously.

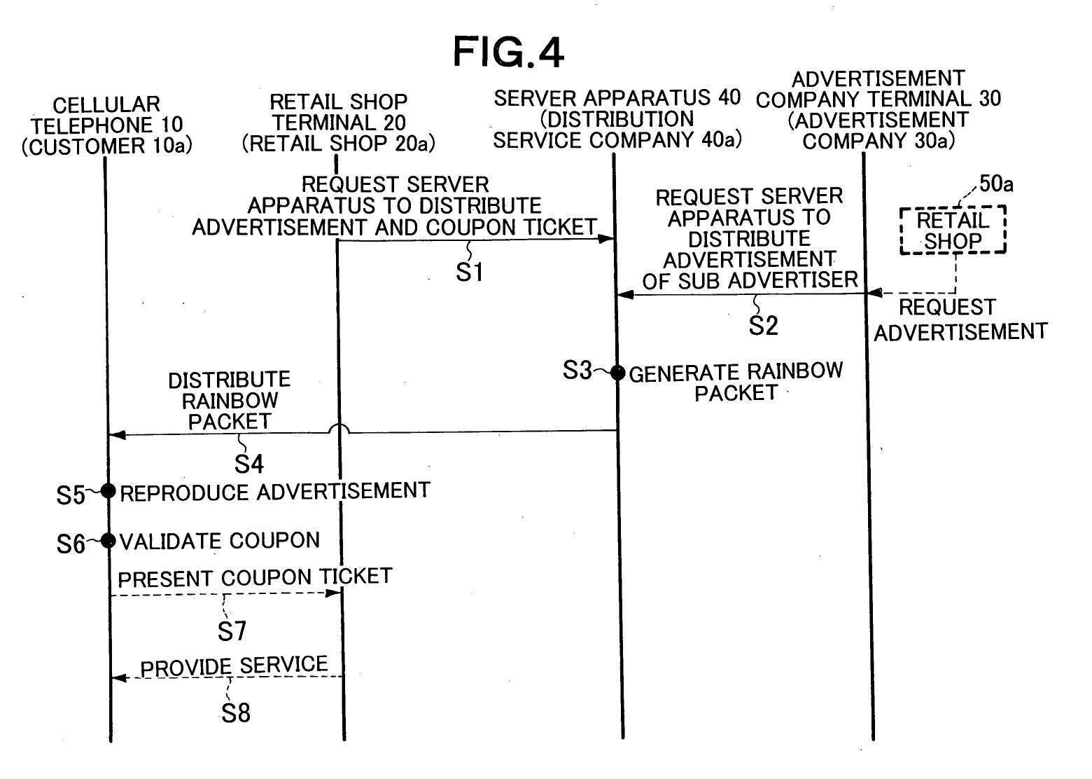

A series of procedures for operations performed by the system 100 according to this embodiment will be described with reference to the sequence chart of FIG. 4. First, the retail shop 20a requests the distribution service company 40a with which the retail shop 20a concluded a contract in advance to distribute an electronic advertisement and a coupon ticket of a campaign (at a step S1). This request can be executed when, for example, the retail shop 20a transmits a predetermined request form to the server apparatus 40 from the retail shop terminal 20.

The retail shop 50a requests the advertisement company 30a to put an advertisement targeted at a customer group of the retail shop 20a. In response to this request, the advertisement company 30a requests the distribution service company 40a that the retail shop 50a can participate, as the sub advertiser, in the electronic advertisement of the retail shop 20a serving as the main advertiser (at a step S2). This request is executed when, for example, the advertisement company 30a transmits a predetermined request form to the server apparatus 40 from the advertisement company terminal 30. The retail shop 20a serving as the main advertiser can earn a predetermined advertisement benefit from the advertisement company 30a in exchange for a contribution to an advertisement activity of the sub advertiser through the intermediary of, for example, the distribution service company 40a.

In the distribution service company 40a that receives the requests from the retail shop 20a and the advertisement company 30a, an operator of the server apparatus 40 stores the advertisement data and coupon ticket data on the retail shop 20a and the advertisement data on the retail shop 50a in the advertisement database 42a or the coupon ticket database 42b. To generate the rainbow packet for the campaign requested by the retail shop 20a, the server apparatus 40 displays an operation screen on a display of the console mechanism 41 and allows the operator to input the configuration of the rainbow packet.

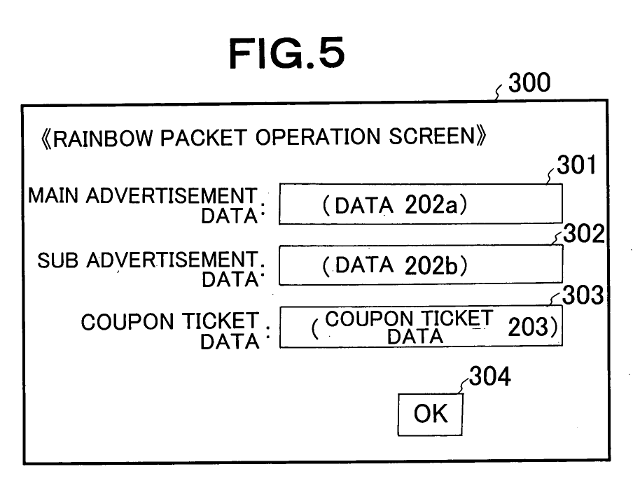

FIG. 5 depicts an example of the operation screen. On an operation screen 300 shown in FIG. 5, values for generating the rainbow packet 200 described with reference to FIG. 3 are input by the operator. As shown in FIG. 5, the data 202a is input to an advertisement data designation box 301 for the main advertiser, the data 202b is input to an advertisement data designation box 302 for the sub advertiser, and the coupon ticket data 203 is input to a coupon ticket data designation box 303. When the operator inputs these values to the respective boxes on the operation screen 300 and depresses an “OK” button 304, the control mechanism 44 detects the input of the values and the depression of the button 304 and starts procedures for generating the rainbow packet generation (at a step S3).

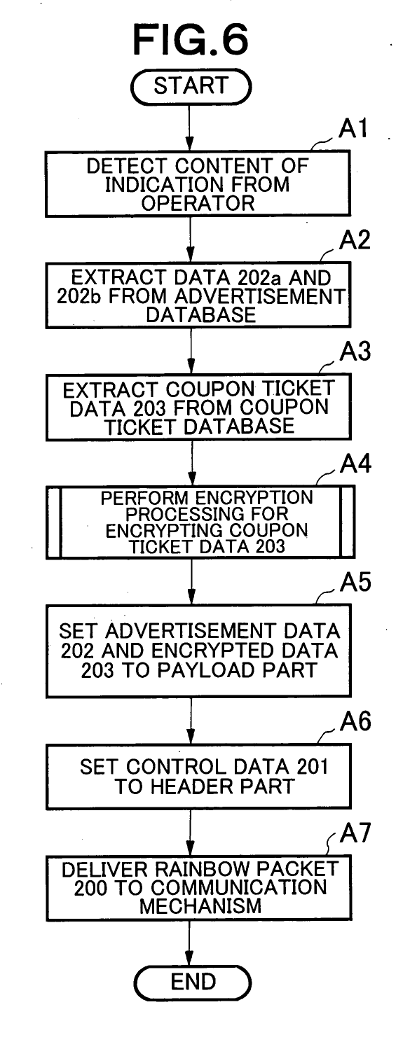

The rainbow packet generation procedures performed by the control mechanism 44 will be described with reference to the flowchart of FIG. 6. First, the packet generation unit 45 detects contents designated on the operation screen (at a step A1). If so, the packet generation unit 45 extracts the data 202a and 202b designated as the advertisement data 202 from the advertisement database 42a (at a step A2). In addition, the packet generation unit 45 extracts the designated coupon ticket data 203 from the coupon ticket database 42b (at a step A3), and the encryption processing unit 46 encrypts this coupon ticket data 203 (at a step A4).

The packet generation unit 45 sets the advertisement data 202 composed by the data 202a and 202b and the encrypted coupon ticket data 203 to the payload part 200b of the rainbow packet 200 (at a step A5). In addition, the packet generation unit 45 sets the control code 201 for indicating the coupon ticket data 203 to be decoded when the reproducing of the advertisement data is completed, to the header part 200a (at a step A6). The rainbow packet 200 is thus completed. Further, the packet generation unit 45 delivers the completed rainbow packet 200 to the communication mechanism 43 so as to distribute the rainbow packet 200 to the cellular telephone 10 (at a step A7), whereby the processing is finished.

Referring back to the sequence chart of FIG. 4, the server apparatus 40 distributes the rainbow packet 200 generated through the above-stated procedures to the cellular telephone 10 through the cellular telephone network 100b using the communication mechanism 43 (at a step S4). On reception of the rainbow packet 200, the cellular telephone 10 reproduces the advertisement in the form of a moving image according to the advertisement data 202 based on the control code 201 (at a step S5). On completion of this reproducing, the cellular telephone 10 decodes the coupon ticket data 203 and effectively displays the coupon ticket on the screen (at a step S6).

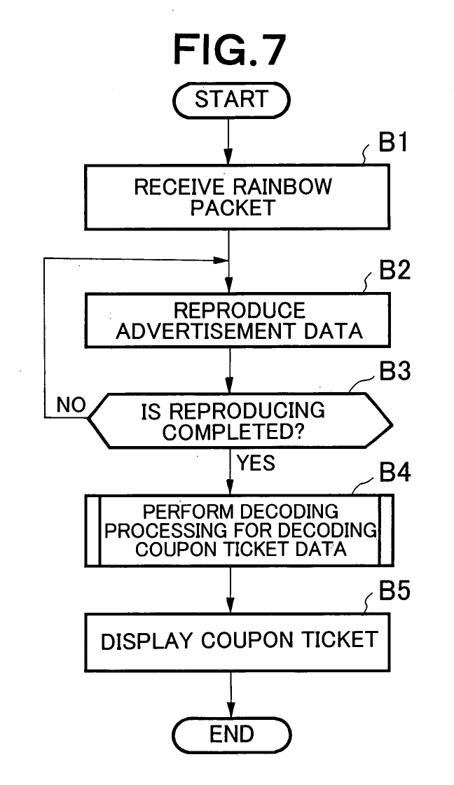

Procedures for operations performed by the cellular telephone 10 will be described with reference to the flowchart of FIG. 7. The cellular telephone 10 receives the rainbow packet 200 from the server apparatus 40 (at a step B1). If so, the display control mechanism 12 of the cellular telephone 10 reproduces the advertisement data 202 and displays the advertisement in the form of the moving image on the LCD 11 (at a step B2).

After the start of the reproducing of the advertisement data 202, the display control mechanism 12 determines whether the reproducing is completed (at a step B3). If determining that the reproducing of the advertisement data 202 is completed, the display control mechanism 12 decodes the coupon ticket data 203 (at a step B4). Using the decoded coupon ticket data 203, the available coupon ticket is displayed on the LCD 11 (at a step B5).

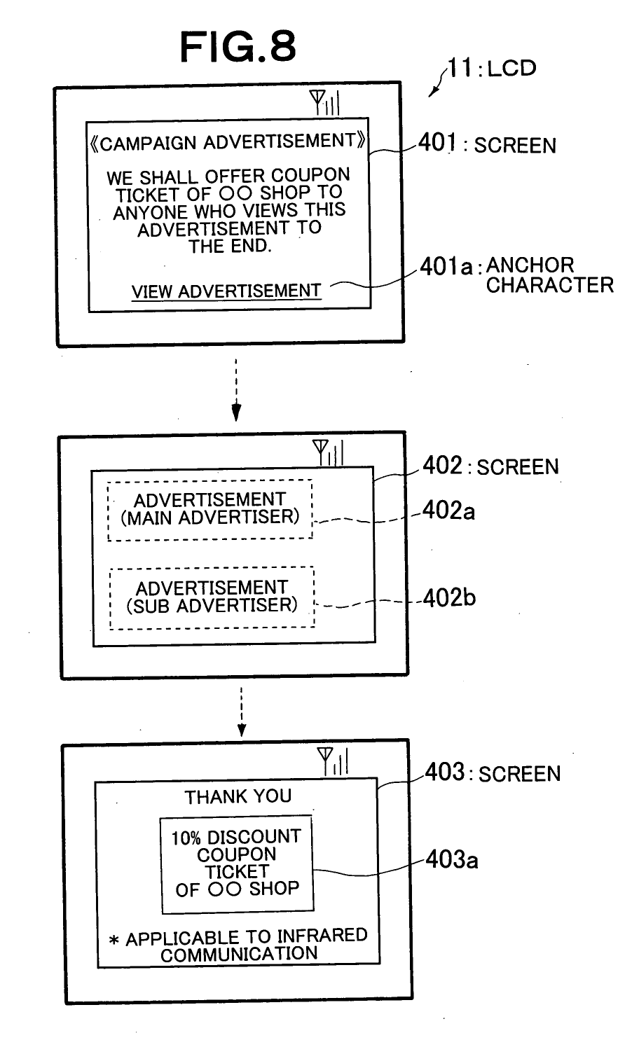

FIG. 8 depicts exemplary screens displayed on the LCD 11 while the cellular telephone 10 executes the steps B1 to B5. When the cellular telephone 10 receives the rainbow packet 200, a screen 401 for urging the customer 10a to view the advertisement is displayed on the LCD 11 of the cellular telephone 10. On the screen 401 shown in FIG. 8, a guidance message to the effect that anyone who views the advertisement to the end can be offered the coupon ticket available at the retail shop 20a as well as an anchor character 401a linked to the reproducing of the advertisement data 202 is displayed.

When the customer 10a designates the anchor character 401a shown in FIG. 8, an advertisement screen in the form of the moving image such as a screen 402 shown in FIG. 8 is displayed. The screen 402 shown in FIG. 8 is the advertisement screen on which an advertisement 402a of the retail shop 20a serving as the main advertiser and an advertisement 402b of the retail shop 50a serving as the sub advertiser are simultaneously displayed. Alternatively, the advertisements 402a and 402b may be continuously displayed at different timings. By thus displaying the advertisement of the sub advertiser together with that of the main advertiser, the sub advertiser can put an advertisement targeted at the customer group of the main advertisement. When the cellular telephone 10 completes the reproducing of the advertisement data 202, a screen 403 including the validated coupon ticket 403a is displayed.

Thereafter, the customer 10a visits the retail shop 20a while carrying the cellular telephone 10, and presents the coupon ticket (403a) to an infrared sensor (not shown) of the POS system 21 using the infrared communication mechanism 13 thereof (at a step S7 shown in FIG. 4). If so, the POS system 21 authenticates the coupon ticket by a conventionally known authentication method. If the POS system 21 authenticates the coupon ticket, the service corresponding to the coupon ticket is provided to the customer 10a (at a step S8 shown in FIG. 4). A series of operation procedures performed by the system 100 according to this embodiment are thereby completed.

According to the system 100 in the above-stated embodiment, the coupon ticket for the cellular telephone 10 which has received the rainbow packet is validated when the reproducing of the advertisement data is completed. It is thereby possible to allow the customer 10a to view the electronic advertisement to the end. This, in turn, can prevent the distributed electronic advertisement from being abandoned without being viewed. In addition, since the retail shop 50a serving as the sub advertiser can put the advertisement targeted at the customer group of the main advertiser, the retail shop 50a can narrow down its advertisement target. The advertisement efficiency can be thereby improved.

The configuration of the advertisement data 202 according to this embodiment is that shown in FIG. 3 in which data on a plurality of advertisers, i.e., the main advertiser and the sub advertiser are included. However, the configuration of the advertisement data is not limited thereto. For example, only the data 202a may be stored in the advertisement data 202 so that the retail shop 20a intends to increase the number of customers of its own shop. Further, an advertisement effect for the main advertiser using the rainbow packet 200 can be attained by at least the coupon ticket. Due to this, the advertisement data 202 may be configured not to include the data 202a on the main advertiser in place of the configuration shown in FIG. 3.

In the above-stated embodiment, the cellular telephone 10 is employed as the information communication terminal according to the present invention. However, the information communication terminal is not limited to the cellular telephone 10 as long as the information communication terminal can communicate with the server apparatus 40. The information communication terminal may be, for example, a personal computer, a personal schedule management terminal or the like.

Moreover, the infrared communication 100c is employed as means for causing the customer 10a to present the coupon ticket to the retail shop 20a. However, this means is not limited to the infrared communication 100c. For example, a method for displaying the coupon ticket in the form of a bar-code on the LCD 11 of the cellular telephone 10 and for reading the bar-code using a bar-code scanner of the POS system 21 may be employed.

According to this embodiment, the server apparatus 40 distributes the rainbow packet during distribution of the electronic advertisement to the cellular telephone 10. Alternatively, during the distribution of the electronic advertisement, data corresponding to the rainbow packet may be directly supplied to the cellular telephone 10 from the POS system 21 of the retail shop 20a through the infrared communication 100c or the like without the intermediary of the distribution service company 40a.

1. An advertisement distribution method comprising steps of:
causing a server apparatus communicable with an information communication terminal to store coupon ticket data for displaying a coupon ticket issued by an advertiser on the information communication terminal, and advertisement data for displaying an advertisement screen that indicates a predetermined advertisement content on the information communication terminal, to encrypt the coupon ticket data, to generate a packet that includes the encrypted coupon ticket data, the advertisement data, and control data for indicating the coupon ticket data to be decoded when display of the advertisement data is completed, and to transmit the generated packet to the information communication terminal; and
causing the information communication terminal to display the advertisement screen corresponding to the advertisement data included in the packet received from the server apparatus, to decode the coupon ticket data when the display of the advertisement screen is completed, and to display the coupon ticket.

2. The advertisement distribution method according to claim 1, wherein
the server apparatus encrypts the coupon ticket data by a common key system.

3. The advertisement distribution method according to claim 2, wherein
the server apparatus divides key data for decoding the coupon ticket data into a predetermined number of key data parts, and inserts the respective predetermined number of key data parts into the advertisement data at predetermined intervals.

4. The advertisement distribution method according to claim 1, wherein
the server apparatus stores data for displaying, as the advertisement data, a advertisement screen corresponding to a plurality of advertisers including advertisers other than the advertiser that issues the coupon ticket.

5. The advertisement distribution method according to claim 1, wherein
the server apparatus stores data for displaying, as the advertisement data, the advertisement content in a form of a moving image.

6. The advertisement distribution method according to claim 1, wherein
the server apparatus stores data for displaying, as the advertisement data, the advertisement content in a form of a static image.

7. The advertisement distribution method according to claim 1, wherein
the server apparatus stores data for enabling the coupon ticket to be presented, as the advertisement data, to the advertiser by infrared communication.

8. An advertisement distribution system comprising:
an information communication terminal; and
a server apparatus communicable with the information communication terminal, wherein
the server apparatus includes:
a data storage unit storing coupon ticket data for displaying a coupon ticket issued by an advertiser on the information communication terminal, and advertisement data for displaying an advertisement screen that indicates a predetermined advertisement content on the information communication terminal;
an encryption processing unit encrypting predetermined coupon ticket data stored in the data storage unit;
a packet generation unit generating a packet that includes the coupon ticket data encrypted by the encryption processing unit, predetermined advertisement data stored in the data storage unit, and control data for indicating the coupon ticket data to be decoded when display of the advertisement data is completed; and
a packet transmission unit transmitting the packet generated by the packet generation unit to the information communication terminal, and wherein
the information communication terminal includes:
a screen display unit displaying the advertisement screen corresponding to the advertisement data included in the packet received from the server apparatus; and
a display control unit decoding the coupon ticket data when it is detected that the screen display unit completes the display of the advertisement screen, and displaying the coupon ticket on the screen display unit.

9. The advertisement distribution system according to claim 8, wherein
the server apparatus encrypts the coupon ticket data by a common key system.

10. The advertisement distribution system according to claim 9, wherein
the server apparatus divides key data for decoding the coupon ticket data into a predetermined number of key data parts, and inserts the respective predetermined number of key data parts into the advertisement data at predetermined intervals.

11. The advertisement distribution system according to claim 8, wherein
the server apparatus stores data for displaying, as the advertisement data, a advertisement screen corresponding to a plurality of advertisers including advertisers other than the advertiser that issues the coupon ticket.

12. The advertisement distribution system according to claim 8, wherein
the server apparatus stores data for displaying, as the advertisement data, the advertisement content in a form of a moving image.

13. The advertisement distribution system according to claim 8, wherein
the server apparatus stores data for displaying, as the advertisement data, the advertisement content in a form of a static image.

14. The advertisement distribution system according to claim 8, wherein
the server apparatus stores data for enabling the coupon ticket to be presented, as the advertisement data, to the advertiser by infrared communication.

15. A server apparatus comprising:
a data storage unit storing coupon ticket data for displaying a coupon ticket issued by an advertiser on an information communication terminal, and advertisement data for displaying an advertisement screen that indicates a predetermined advertisement content on the information communication terminal;
an encryption processing unit encrypting predetermined coupon ticket data stored in the data storage unit;
a packet generation unit generating a packet that includes the coupon ticket data encrypted by the encryption processing unit, predetermined advertisement data stored in the data storage unit, and control data for indicating the coupon ticket data to be decoded when display of the advertisement data is completed; and
a packet transmission unit transmitting the packet generated by the packet generation unit to the information communication terminal.
